(19) United States
(12) Patent Application Publication
(10) Pub. No.: US 2006/0271685 A1
(43) Pub. Date: Nov. 30, 2006

(54) Function initiation in a network device using a limited keypad

(76) Inventors: Matthew B. McRae, Laguna Beach, CA (US); Kendra S. Harrington, Irvine, CA (US); Allen J. Huotari, Garden Grove, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/139,169

(22) Filed: May 26, 2005

(51) Int. Cl. G06F 15/16

(52) U.S. Cl. 709/227

(57) ABSTRACT

Systems and methods are provided for initiating functions on a network connectivity device, such as a router. A keypad sequence is input into the control device using a limited keypad. A command is transmitted to the router, and the router performs a function in response to the command. Accordingly, telephone handsets may be utilized to generate control commands to a router.

### BACKGROUND

In conventional home networks and small office/home office (SOHO) networks, a router is used to connect the local-area network (LAN) to a wide-area network (WAN), such as the Internet. To improve the ease of implementing a LAN, combination devices are sold that combine into a single device multiple network connectivity functions, such as a router, a switch, and a wireless access point (WAP). One such currently available combination device is the Wireless-G Broadband Router (Model WRT54G) by Linksys, a division of Cisco Systems, Inc., of San Jose, Calif. This combination device can then be connected to a cable or DSL modem in order to provide WAN connectivity to all devices on the LAN. In other combination devices, the modem function is also bundled with the router, switch, and WAP functions. One such currently available combination device is the Wireless-G Cable Gateway (Model WCG200) by Linksys.

Users can typically configure and manage these network connectivity devices by using a personal computer (PC) to either access a browser-based graphical user interface (GUI) hosted by the router or a Setup Wizard application running on the PC. In either case, a PC including keyboard and mouse input devices is used to interface with the GUI to perform the desired functions or initiate the desired actions.

With the increased availability of broadband Internet connections, the use of Voice over Internet Protocol (VoIP) to make telephone calls over the Internet has also increased. Various hardware manufacturers have developed VoIP-enabled telephone devices to make use of this technology. Some of these VoIP telephone handsets are similar in design to conventional analog telephones, but can be used to place telephone calls over a LAN using VoIP technology. WiFi VoIP handsets may be used over wireless LANs (WLANs) using VoIP and WiFi technology. In addition, dual-mode mobile telephone devices have been developed which are capable of transmitting voice communications using VoIP over WLANs and also using traditional cellular communications networks. Despite the increased availability of VoIP-enabled telephone devices, the limited numeric keypad, small display, and limited processing power of these telephones has restricted the telephones' utilization for performing functions other than voice communication and simple gaming.

With the increased convergence of telephone functions and networked computing, it would be desirable to provide a system for enabling a user to utilize a telephone device to configure and manage network connectivity devices.

### DESCRIPTION OF THE DRAWINGS

FIG. 1 is a block diagram showing an exemplary data communications network for initiating functions on a network connectivity device, in accordance with embodiments of the present invention.

FIG. 2 is a block diagram showing an exemplary data communications network for initiating functions on a network connectivity device, in accordance with another embodiment of the present invention.

FIG. 3 is a block diagram showing an exemplary data communications network for initiating functions on a network connectivity device, in accordance with another embodiment of the present invention.

FIG. 4 is a block diagram showing an exemplary data communications network for initiating functions on a network connectivity device, in accordance with another embodiment of the present invention.

FIG. 5 is a flowchart illustrating a method of initiating functions on a network connectivity device using a control device having a limited keyboard, in accordance with another embodiment of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

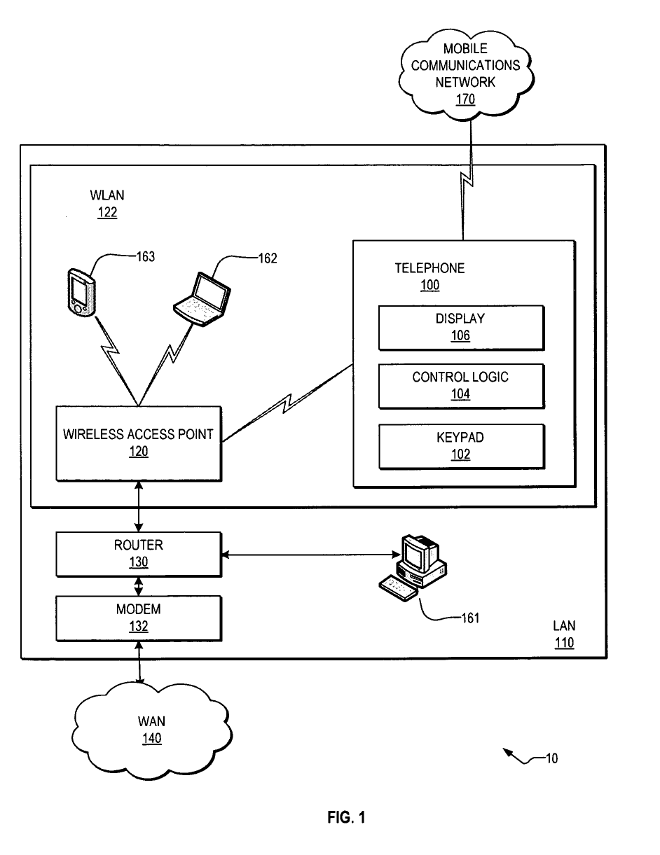

FIG. 1 is a block diagram showing an exemplary data communications network 10 for initiating functions on a network connectivity device using a control device having a limited keypad, in accordance with embodiments of the present invention. In the illustrated embodiment, the data communications network 10 comprises a local area network (LAN) 110 coupled to a wide-area network (WAN) 140, such as, e.g., the Internet.

The LAN 110 includes a router (and/or switch) 130 coupled to a modem 132 that provides an interface to the WAN 140. The router 130 and the modem 132 may be implemented as separate devices or as a single unit, such as a gateway network device.

A wireless access point (WAP) 120 provides wireless network connectivity to the LAN 110 via a wireless local-area network (WLAN) 122. The WAP 120 may comprise any device that allows wireless-enabled computers and other devices to communicate with a wired network. The WLAN 122 may comprise a wireless network compliant with the standards governed by, e.g., IEEE 802.11 (“WiFi”), IEEE 802.15.1 (“Bluetooth”), ultra wideband (UWB) radio, and the like. The WAP 120 may also be implemented as a separate device or combined with the router 130.

Multiple devices may be connected to the LAN 110. For example, one or more personal computers (PC) 161 may be coupled to the router 130 via conventional network cabling. In addition, other devices, such as, e.g., telephone 100, laptop computer 162, and personal digital assistant (PDA) 163, may be configured to wirelessly connect to WLAN 122.

As described above, network connectivity devices, such as the router 130, are conventionally managed using a browser or Setup Wizard application running on a PC. As a general matter, it is easier to initiate functions on the router 130 using a control device having a full keyboard and a mouse as input devices, such as, e.g., PC 161. The keyboard/mouse man/machine interface is well-established as the primary mode of managing computing devices. Unfortunately, these input devices and the large display for the PC 161 make the PC 161 suitable for stationary use only, such as when the user is sitting at his or her desk. Even a laptop computer 162 is generally too bulky to be carried around the office with any frequency. However, the compact and mobile nature of the wireless telephone handset 100 makes it easy for the user to carry the handset 100 at all times. Therefore, it would be desirable to enable users to utilize the handset 100 to initiate functions on the router 130.

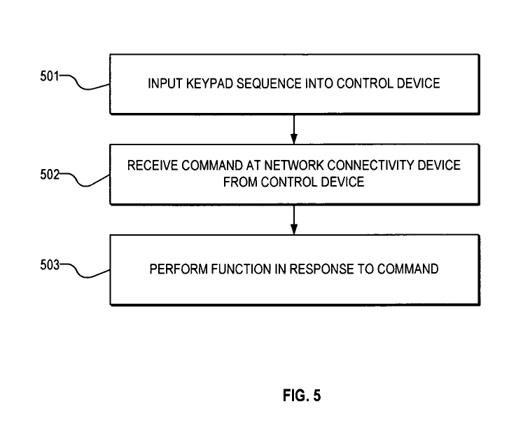

FIG. 5 is a flowchart illustrating a method of initiating functions on a network connectivity device using a control device having a limited keyboard, in accordance with embodiments of the present invention. A network connectivity device is a device that connects LANs or segments of LANs, such as a repeater, hub, bridge, router, or switch. These network connectivity devices may operate in one or more of the physical, data link, and network layers of the network model. In the embodiment illustrated in FIG. 1, the network connectivity device on which the functions are initiated comprises a router, such as the type used in home networks. In other embodiments, the network connectivity device may comprise other devices in the LAN, such as, e.g., a combination device incorporating both the WAP 120 and the router 130.

In step 501, the keypad sequence is input into a control device having a limited keypad. In step 502, a command is received at the network connectivity device from the control device. In step 503, a function is performed in response to the command.

In the embodiment shown in FIG. 1, the control device having the limited keypad is the telephone handset 100. In the illustrated embodiment, the telephone handset 100 is a dual-mode mobile station configured to establish wireless network connectivity to two different types of wireless networks. Handset 100 is capable of establishing a first network connection to the WLAN 122 via the WAP 120, and a second network connection to a mobile communications network 170. When the handset 100 is within the coverage area of the WLAN 122, the handset 100 communicates encoded Internet Protocol (IP) packets (either voice bearing or data bearing) to and from the WAP 120. When the handset 100 is beyond the coverage area of the WLAN 122, the handset 100 utilizes the mobile communications network 170 for communication. The mobile communications network 170 may utilize any of a variety of mobile communications network protocols, such as, e.g., a Global System for Mobile Communications (GSM) system that incorporates General Packet Radio Service (GPRS), Code Division Multiple Access (CDMA), or Time Division Multiple Access (TDMA).

A dual-mode cellular phone, such as telephone handset 100, enables a user to utilize VoIP, which allows users to bypass standard phone lines by using the Internet for placing and receiving telephone calls. In addition, a user may utilize a dual-mode cellular phone to transmit and receive data via the WLAN, without utilizing the cellular network. Thus, WLANs permit dual-mode mobile device users to bypass the traditional cellular network by using the Internet to route telephone calls instead. This can potentially reduce communication costs for users and cellular service providers by reducing the amount of cellular bandwidth utilized by the cellular phone for voice and data. In other embodiments, the telephone handset 100 does not also include cellular functionality and only establishes a network connection to the WLAN 122. Therefore, the mobile communications network 170 may be omitted.

Because the telephone handset 100 is intended primarily for voice communication, the input device for the handset 100 includes a limited keypad. A limited keypad is an input device having fewer keys than a full QWERTY keyboard, as is commonly provided on PC desktop and laptop computers which are designed for extensive manual data input. One commonly used limited keypad is the numeric keypad found on conventional analog telephones, which includes keys for the numbers 0-9, a star (*) key, and a pound (#) key.

In many numeric keypads used for telecommunications devices, each of the numbered keys are mapped to multiple alphabetic letters. For example, in standard telephones, the “2” key also corresponds to the letters A, B, and C, the “3” key also corresponds to the letters, D, E, and F, and so on. Typical mobile telephone handsets are provided with additional keys for use in, for example, initiating and terminating telephone calls, navigating menus in the user interface for the handset, and adjusting settings, such as ringer or speaker volume. However, due to the compact size of the telephone handset, the total number of keys that can be provided is limited, often to between 12 and 20 keys.

Various modes of communication between the control device and the network connectivity device may be used. In FIG. 1, the control device is a WiFi enabled telephone handset 100 comprising a fully functional IP client on a WiFi network, WLAN 122. The handset 100 includes a limited keypad 102 and control logic 104 for controlling the operation of the handset 100. The control logic 104 is configured to generate commands to be transmitted to the router 130 in response to detecting one or more predetermined sequences of keypad entries. These commands are transmitted over the WLAN 122 and received by the router 130, which performs the requested functions in response to the commands from the handset 100.

A variety of functions may be performed by the network connectivity device in response to the command from the control device. These functions may be configured either by the manufacturer of the network connectivity device or may be customized by the end user. The function performed by the router in response to the command from the control device may include configuring a router setting, such as, e.g., setting a content filtering/parental control setting, opening or closing of a port in a firewall provided by the router 130, and changing a profile setting on the router. The function performed by the router may also include rebooting the router.

Another possible function to be performed by the router in response to the command from the control device includes transmitting an instruction to a networked device to perform a task. For example, the router may be used to transmit control commands to any other device on the LAN 110, such as an entertainment device (e.g., a television or stereo) or a home automation device (e.g., a light, HVAC controls, or a home automation control system).

Another possible function to be performed by the router in response to the command from the control device includes providing information to the control device. For example, when a user enters a particular keypad sequence, the handset 100 will transmit a request for information to the router 130. In response, the router 130 will transmit the requested information back to the handset 100. This information may be communicated by the handset to the user using displayed text, such as a Short Messaging Service (SMS) message. Alternatively, this information may be communicated to the user via an audible message broadcast by a speaker on the handset 100. Various types of information may be provided by the router 130 to the handset 100, for example: the status of a particular setting, a setting value, the status of connectivity to the WAN (e.g., the Internet), the number of wireless clients coupled to the LAN 110, a log, a network client enumeration, or a Uniform Resource Locator (URL).

The command may be transmitted by the control device to the network connectivity device in a variety of ways. For example, the control logic 104 for the handset 100 may be configured to transmit messages to the router 130 using a variety of communication protocols, such as, e.g., Extensible Markup Language (XML), Simple Network Management Protocol (SNMP), HyperText Markup Language (HTML), HyperText Transfer Protocol (HTTP), or Simple Object Access Protocol (SOAP). The router 130 may be configured to respond to the messages from the handset 100 using a similar protocol.

The transmission of the command from the handset 100 may be triggered in a variety of ways. Because the handset 100 is primarily intended for use as a telephone, it may be desirable for the control logic 104 to recognize a particular sequence of keypad inputs as a “wake-up” sequence that represents a control message to the router 130. Thus, when the control logic 104 detects the “wake-up” sequence of keypad inputs, the control logic 104 will interpret the keypad inputs to generate the command to be transmitted to the router 130, rather than interpreting the keypad inputs as inputs for the telephone function, such as dialing a telephone number.

In other embodiments, the handset 100 may be provided with a dedicated key for interrupting the telephone function and initiating the router control function of the handset 100. However, a disadvantage of this approach is that one of the limited number of keys available on the keypad 102 will be consumed by this dedicated key. In yet other embodiments, the router control function of the handset 100 may be initiated by navigating a menu of functions displayed on a display 106 of the handset 100 and selecting the router control function. Once the handset 100 is placed into router control mode, subsequent keypad entries will be interpreted by the control logic 104 to determine the command to be transmitted to the router 130. Other variations utilizing the limited keypad of the control device are possible.

The following are examples of functions that may be initiated on a router using a limited keypad handset, in accordance with various embodiments of the present invention.

### EXAMPLE #1

In the first example, a user enters a predetermined keypad sequence in order to retrieve information from the router 130 via a limited keypad telephone (e.g., the WiFi handset 100). The user initiates the process by pressing “*551” on the keypad 102. The control logic 104 is programmed to respond to this keypad sequence by transmitting a command to the router 130 via WLAN 122. This command queries the router 130 for information on the router's Parental Control setting. In response to receiving this command, the router 130 checks the Parental Control setting and transmits a response message to the handset 100 via the WLAN 122. This response message, which could be, e.g., in XML, would contain information regarding whether the Parental Control feature is activated or deactivated.

In this example, the keypad sequence of “*551” causes the handset 100 to transmit the command to the router 130. The first two keypad inputs (“*5”) indicate to the control logic 104 that the router control function is being invoked. The second two keypad inputs (“51”) indicate to the control logic 104 which command to transmit (i.e., request information regarding the Parental Control setting).

### EXAMPLE #2

In the second example, a user enters a predetermined keypad sequence in order to change a setting on the router 130 via the handset 100. The user initiates the process by pressing “*56200” on the keypad 102. As in Example #1, the first two keypad inputs (“*5”) indicate to the control logic 104 that the router control function is being invoked. In this example, the next keypad input (“6”) indicates to the control logic 104 that the user would like to open a port in the router's firewall. The final three keypad inputs (“200”) indicate to the control logic 104 that the desired port to be opened is port 200. Thus, in response to detecting the keypad sequence of “*56200”, the control logic 104 transmits a message to the router 130 instructing the router to open port 200 in the firewall. Upon receipt of this command from the handset 100, the router 130 will attempt to open port 200 in the firewall. The router 130 may optionally be configured to transmit a response message to the handset 100. This response message is displayed to the user on the display 106 to indicate to the user whether the requested action was successful.

### EXAMPLE #3

In the third example, a user again enters a predetermined keypad sequence in order to change a setting on the router 130 via the handset 100. In this case, the user enters the keypad sequence “*591”. Again, the first two keypad inputs (“*5”) indicate to the control logic 104 that the router control function is being invoked. Here, the next two keypad inputs (“91”) indicate to control logic 104 that the user wishes to change the telephone number assigned to the VoIP ports on the router 130. This feature could be used when the user is at home and wishes to have analog phone(s) attached to the router's VoIP ports receive calls directed to the user's cellular telephone number. In this example, the “9” indicates that the telephone number assigned to the VoIP ports is to be changed. The “1” indicates the telephone number to use. The router may be preprogrammed with a plurality of telephone numbers, with “1” indicating a first telephone number to use for the VoIP ports, “2” indicating a second telephone number to use, and so on.

### EXAMPLE #4

In the next example, the user enters the keypad sequence “*582” in order to change a setting on the router 130 via the handset 100. Again, the first two keypad inputs (“*5”) indicate to the control logic 104 that the router control function is being invoked. Here, the next two keypad inputs (“82”) indicate to control logic 104 that the user wishes to transmit a Point-to-Point Protocol over Ethernet (PPPoE) username and password to the router 130. In response to this keypad sequence, the control logic 104 first invokes a program on the handset 100 to prompt the user to enter the PPPoE username and password. Once the user has entered the username and password, the control logic 104 will transmit a message to the router 130 containing the user's PPPoE username and password. This information would be used to authenticate the router on the WAN 140.

In this case, the entry of the username and password can be accomplished, for example, by displaying a template on the handset display 106 to allow the user to enter the requested information. The user may utilize the limited keypad to enter alphanumeric characters for the username and password using a conventional alphanumeric multi-press typing method, as is currently used on many cellular phones. According to this typing method, the user selects alphanumeric characters by repeatedly pressing one of the keys and cycling through the associated alphanumeric options until a pause or selection of another key by the user indicates a choice has been made.

### EXAMPLE #5

A user may also enter a keypad sequence on the handset 100 to transmit a command to another device on the LAN 110 through the router 130. In this example, when the user presses the keypad sequence “*581”, the control logic 104 will transmit a command to the router 130, instructing the router 130 to transmit a command to the target device. This command could be used, for example, to control a home management device (e.g., to turn interior lights on/off), to activate a media adapter (e.g., to turn on the radio), to activate a networked camera to take a photograph or begin recording video, and the like. This method can be used to enable a user to use the handset 100 to control any device that is configured to receive commands over the LAN 110.

### EXAMPLE #6

A user may also enter a keypad sequence on the handset 100 to send a command to the router 130 to instruct the router 130 to transmit information to another device on the LAN 110. For example, when a user presses “*55551#” on the keypad 102, a command is transmitted to the router 130 to trigger the router 130 to initiate an upstream identity announcement. In response, the router 130 will transmit a Dynamic Host Configuration Protocol (DHCP) INFORM packet upstream to a server address pre-programmed into the router 130. This procedure may be used as a diagnostic tool. For example, if the INFORM packet is transmitted, but no reply is received from the server, it could be inferred that the Internet connection for the router 130 is down.

In this example, the keypad sequence has a modified format from the examples above. Here, the pound (#) input is provided at the end of the keypad sequence to indicate the end of the control input sequence. Other variations are possible.

### EXAMPLE #7

A user may also enter a keypad sequence on the handset 100 to send a command to the router 130 to instruct the router to perform diagnostics and respond to the handset 100 with a status message indicating the result of the diagnostic test. For example, when a user enters the keypad sequence “*55552#”, the control logic 104 will transmit a command to the router 130 to diagnose the LAN and WAN connections. After this diagnostic is performed, the router 130 will transmit a message back to the handset 100 to be displayed on the display 106 indicating the status of the LAN and WAN connections.

### EXAMPLE #8

A user may also enter a keypad sequence on the handset 100 to first cause the handset 100 to display a list of available commands, and then to transmit one of the commands to the router 130 in response to a selection by the user of that command from the list of commands. For example, when a user presses the sequence “*77#”, the control logic 104 causes a list of available commands to be displayed on the display 106 of the handset 100. The user may utilize navigation keys on the keypad 102 to scroll through the available commands and to select the desired command. Once the desired command is selected, the handset 100 will transmit the selected command to the router 130 to be performed.

In another embodiment, the list of available commands could be made viewable on the display 106 by adding them to the existing “menu” available on the handset 100. This “menu” is typically used in conventional cellular telephones to allow a user to select and navigate an address book or calendar function. The use of the “menu” would enable a user to bypass the use of the numeric keypad sequence “*77#” to invoke the display of available commands.

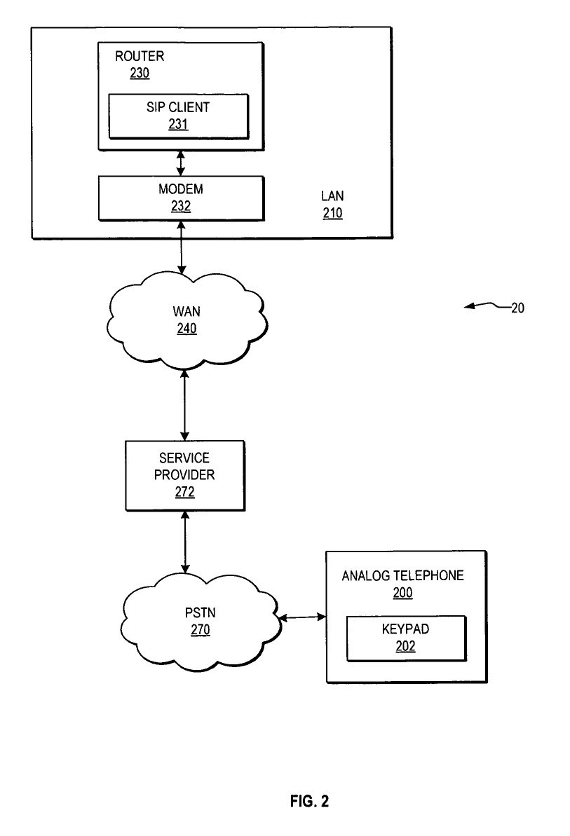

FIG. 2 is a block diagram showing an exemplary data communications network 20 for initiating functions on a network connectivity device, in accordance with another embodiment of the present invention. In the illustrated embodiment, the data communications network 20 comprises a LAN 210 coupled to a WAN 240. The LAN 210 includes a router 230 coupled to a modem 232. The router 230 includes a Session Initiation Protocol (SIP) client 231 which enables the router 230 to interface with any standard analog telephone by responding to the Dual-Tone Multi-Frequency (DTMF) tones generated when the keys of the analog telephone are pressed. The router 230 may be provided with VoIP ports for connection with a telephone, or may not be provided with such ports.

In this embodiment, the user utilizes a standard analog telephone 200 having a standard twelve key (0-9, #, *) keypad 202 to initiate functions on the router 230. This telephone 200 is connected to the Public Switched Telephone Network (PSTN) 270. In order to connect with the router 230, the user places a call to a telephone number assigned to the SIP client 231 of the router 230. This call would pass through the PSTN 270 to a SIP service provider 272. The SIP service provider 272 would forward the call to the SIP client 231 via the WAN 240. Once the SIP client 231 connects with the telephone 200, the user may enter a keypad sequence into the keypad 202 to trigger the SIP client 231 in the router 230 to respond to subsequent DTMF tones. Once the telephone 200 has connected to the router 230, the router 230 can respond to various keypad sequences input into the keypad 202, as described in the various examples above.

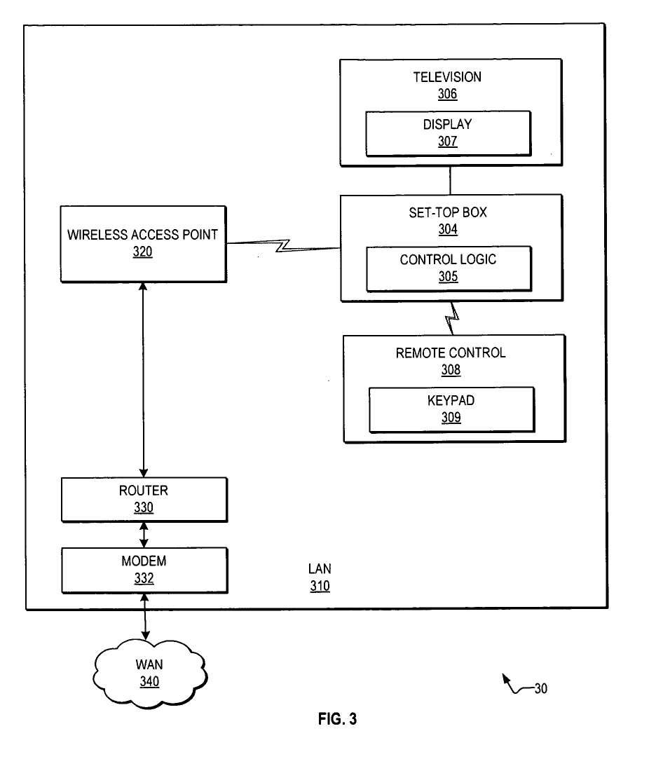

FIG. 3 is a block diagram showing an exemplary data communications network 30 for initiating functions on a network connectivity device, in accordance with another embodiment of the present invention. The data communications network 30 comprises a LAN 310 coupled to a WAN 340. The LAN 310 includes a router 330 coupled to a modem 332. A WAP 320 provides wireless network connectivity to the LAN 310 via a WLAN.

In this embodiment, the user utilizes a remote control device 308 to initiate functions on the router 330. This remote control 308 may be similar to conventional remote controls and include an infrared (IR) interface for transmitting control signals to, e.g., a television, a set-top box (STB), a home theater receiver, a home automation system, and the like. Like conventional remote controls, the remote control 308 includes a limited keypad 309 having fewer keys than a standard QWERTY keyboard. The keypad 309 may include, for example, number keys 0-9, volume up/down, channel up/down, and other keys conventionally used for controlling entertainment devices.

The remote control 308 transmits IR signals to a set-top box (STB) 304, which includes control logic 305. The STB 304 may be primarily used to receive signals, e.g., from a satellite dish, a cable line, or a computer on the LAN 310, to cause a video image to be displayed on the display 307 of a television 306. The control logic 305 enables the STB 304 to transmit commands to the router 330.

The user may activate the control function of the STB 304 by pressing a “wake-up” keypad sequence on the keypad 309 of the remote-control 308. Because many conventional remote control keypads do not include the * and # telephone function keys, an alternative “wake-up” keypad may be used instead of those described above to signal to the control logic 305 that a command for the router 330 is being issued by the user. For example, the keypad sequence “0000” would not normally be used for any other input on the entertainment system, and therefore may be appropriate for use as the unique “wake-up” keypad sequence. Once the control logic 305 recognizes that the control function has been initiated, any subsequent keypad sequences can be used to designate various commands to be transmitted to the router 330.

The STB 304 may use the display 307 of the television 306 to display messages and menus to the user. This can enable the user to select from a list of available commands to be transmitted to the router 330, or may be used to display information provided by the router 330 in response to requests for information transmitted by the STB 304.

In other embodiments, control logic may also be implemented in the remote control 308 for recognizing and interpreting keypad sequences entered into the keypad 309. In yet other embodiments, the remote control 308 may be used to transmit signals to another type of home entertainment device, such as, e.g., a stereo system, rather than a STB.

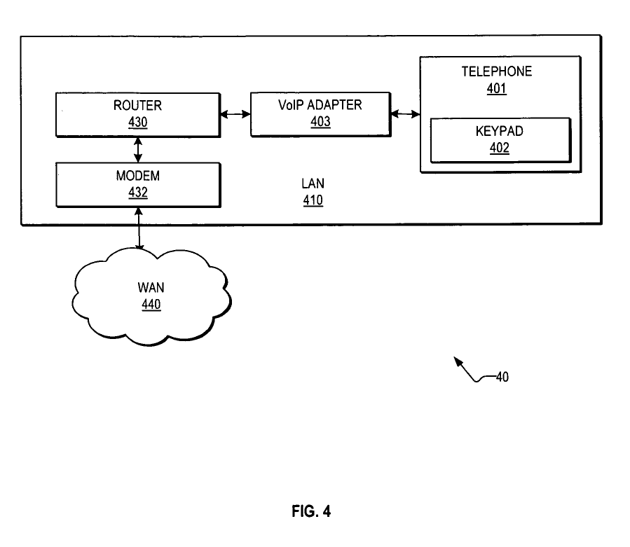

FIG. 4 is a block diagram showing an exemplary data communications network 40 for initiating functions on a network connectivity device, in accordance with another embodiment of the present invention. In the illustrated embodiment, the data communications network 40 comprises a LAN 410 coupled to a WAN 440. The LAN 410 includes a router 430 coupled to a modem 432 and a VoIP adapter 403. A standard analog telephone 401 having a limited keypad 402 is coupled to the VoIP adapter 403. This telephone 401 may be used to place telephone calls using VoIP, similar to the handset 100 in FIG. 1. The use of the telephone 401 to initiate functions on the router 430 is substantially similar to the use of the handset 100 in FIG. 4. However, in this embodiment, the LAN 410 does not include a WLAN, so the telephone 401 is coupled to the router 430 via network cabling.

In another embodiment, the telephone device having the limited keypad is VoIP telephone that has a wired connection to a router in a LAN. In this case, because the telephone is already VoIP-enabled, a separate VoIP adapter 403 is not needed.

Security is of significant concern for computer networks. Therefore, it would be desirable to implement security measures to ensure that any function initiated on a network device is performed using an authorized mechanism. In embodiments in which a limited keypad device connects to the LAN via a WLAN, network security is provided by the wireless authentication process used by the WLAN. In the embodiment described with respect to FIG. 2, an analog telephone 200 connects to the router 230 via the PSTN by dialing a telephone number associated with that router 230. In this case, the security can be provided by maintaining the secrecy of the telephone number of the router 230. As an additional security precaution, the router 230 may request that the user enter a PIN (personal identification number) code before allowing the user to initiate functions on the router. In yet other embodiments, security is provided by designating a particular mobile device as the only authorized mobile device for controlling network devices on a particular LAN. No other devices will be allowed to initiate functions on that LAN, and that designated device cannot be used to initiate functions on any other LAN. Other types of security procedures may be used to ensure that the controlling device is properly authenticated.

Embodiments of the present invention may provide various advantages not provided by prior art systems. Any type of device having a limited keypad and a connection to the network connectivity device (e.g., the router) may be used to initiate functions on the network connectivity device. The connection to the network connectivity device can be by any method, such as, e.g., IEEE 802.11, HomePlug, Ethernet, USB, Bluetooth, and the like. No personal computer, browser application, or Setup Wizard is needed to configure and manage the router. In addition, a simple telephone may be used to trigger functions inside of a home network via the router or to query for specific information. Furthermore, the telephone can be used as a configuration and/or information client for the router by transmitting commands to the router and by receiving information from the router.

While the invention has been described in terms of particular embodiments and illustrative figures, those of ordinary skill in the art will recognize that the invention is not limited to the embodiments or figures described. For example, methods and systems suitable for use in small office/home office (SOHO) networks have been described. In other embodiments, the methods and systems may be deployed in other environments as well, such as in an enterprise network. The precise configuration and scale of the network in which these systems and methods are utilized may vary.

In many of the embodiments described above, the limited keypad telephone device comprises a WiFi handset for wirelessly placing telephone calls over a LAN. In other embodiments, the limited keypad telephone device need not be WiFi-enabled. In some embodiments, the telephone is a device that does not use IP to communicate, such as a conventional analog telephone.

In addition, the particular keypad sequences described in the examples above are merely exemplary. It will be understood that other keypad sequences and keys other than the standard telephone function keys (0-9, *, #) may be used.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of initiating functions on a network connectivity device, comprising:
receiving a command at the network connectivity device from a control device having a limited keypad; and
performing a function in response to the command.

2. The method of claim 1, wherein:
said network connectivity device comprises a router;
said performing the function in response to the command comprises performing the function on the router in response to the command; and
said control device having the limited keypad comprises a telephone.

3. The method of claim 2, further comprising:
receiving at the telephone a keypad sequence; and
interpreting the keypad sequence to determine a desired function.

4. The method of claim 3, wherein:
said interpreting the keypad sequence to determine the desired function is performed by the telephone; and
said receiving the command at the network connectivity device comprises receiving the command corresponding to the desired function at the network connectivity device.

5. The method of claim 3, wherein:
said interpreting the keypad sequence to determine the desired function is performed by the network connectivity device.

6. The method of claim 5, wherein:
said interpreting the keypad sequence to determine the desired function comprises interpreting a sequence of Dual-Tone Multi-Frequency (DTMF) tones to determine the desired function.

7. The method of claim 5, wherein:
said router comprises a Session Initiation Protocol (SIP) client.

8. The method of claim 2, wherein:
said performing the function comprises configuring a setting on the router.

9. The method of claim 8, wherein:
said configuring the setting on the router comprises one of: setting a content filtering setting, opening or closing a port in a firewall, and selecting a profile comprising a preselected group of setting values.

10. The method of claim 2, wherein:
said performing the function comprises rebooting the router.

11. The method of claim 2, wherein:
said performing the function comprises transmitting from the router to a networked device an instruction to perform a task.

12. The method of claim 1, wherein:
said command from the control device comprises a request for information; and
said performing the function comprises transmitting from the network connectivity device to the control device the requested information.

13. The method of claim 12, wherein:
said requested information comprises one of: a status of a setting, a setting value, a status of connectivity to a wide-area network (WAN), a number of wireless clients coupled to the local-area network (LAN) of the network connectivity device, a log, a network client enumeration, a Uniform Resource Locator (URL).

14. The method of claim 12, further comprising:
displaying the requested information on a display of the control device.

15. The method of claim 1, wherein:
said receiving the command comprises receiving the command according to one of the following protocols: Extensible Markup Language (XML), Simple Network Management Protocol (SNMP), HyperText Markup Language (HTML), HyperText Transfer Protocol (HTTP), or Simple Object Access Protocol (SOAP).

16. The method of claim 1, wherein:
said control device comprises a remote control for controlling an entertainment device.

17. A system for initiating functions on a network connectivity device using a control device having a limited keypad, comprising:
a network connectivity device configured to receive a command from the control device, wherein the command is input into the control device using the limited keypad, and to perform a function in response to the command.

18. The system of claim 17, wherein:
said network connectivity device comprises a router; and
said control device having the limited keypad comprises a telephone.

19. The system of claim 18, wherein:
said telephone is configured to receive a keypad sequence and interpret the keypad sequence to determine a desired function.

20. The system of claim 18, wherein:
said router is configured to receive a keypad sequence and interpret the keypad sequence to determine a desired function.

21. The system of claim 20, wherein:
said router is configured to interpret a sequence of Dual-Tone Multi-Frequency (DTMF) tones to determine the desired function.

22. The system of claim 20, wherein:
said router comprises a Session Initiation Protocol (SIP) client.

23. The system of claim 18, wherein:
said router is configured to perform the function by configuring a setting on the router.

24. The system of claim 23, wherein:
said router is configured to configuring the setting on the router by: setting a content filtering setting, opening or closing a port in a firewall, or selecting a profile comprising a preselected group of setting values.

25. The system of claim 18, wherein:
said router is configured to perform the function by rebooting the router.

26. The system of claim 18, wherein:
said router is configured to perform the function by transmitting from the router to a networked device an instruction to perform a task.

27. The system of claim 17, wherein:
said command from the control device comprises a request for information; and
said network connectivity device is configured to perform the function by transmitting to the control device the requested information.

28. The system of claim 27, wherein:
said requested information comprises one of: a status of a setting, a setting value, a status of connectivity to a wide-area network (WAN), a number of wireless clients coupled to the local-area network (LAN) of the network connectivity device, a log, a network client enumeration, a Uniform Resource Locator (URL).

29. The system of claim 27, wherein:
the control device is configured to display the requested information on a display of the control device.

30. The system of claim 17, wherein:
said command is transmitting according to one of the following protocols: Extensible Markup Language (XML), Simple Network Management Protocol (SNMP), HyperText Markup Language (HTML), HyperText Transfer Protocol (HTTP), or Simple Object Access Protocol (SOAP).

31. The system of claim 17, wherein:
said control device comprises a remote control for controlling an entertainment device.
